(19) United States
(12) Patent Application Publication
(10) Pub. No.: US 2010/0241597 A1
(43) Pub. Date: Sep. 23, 2010

(54) DYNAMIC ESTIMATION OF THE POPULARITY OF WEB CONTENT

(76) Inventors: Bee-Chung Chen, Mountain View, CA (US); Pradheep Elango, Mountain View, CA (US); Deepak K. Agarwal, Sunnyvale, CA (US); Wei Chu, Sunnyvale, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/407,785

(22) Filed: Mar. 19, 2009

(51) Int. Cl. G06F 15/18; G06F 15/16

(52) U.S. Cl. 706/12; 709/204

(57) ABSTRACT

Techniques are presented for estimating the current popularity of web content. Click and view data for articles are used to estimate popularity of the articles by analyzing click-through rates. Click-though rates are estimated such that a current click-through rate reflects fluctuations in popularity of articles through time.

### FIELD OF THE INVENTION

The present invention relates to techniques for estimating the popularity of web content, and in particular, for dynamically estimating the changing popularity of web content over time.

### BACKGROUND

Content is being frequently updated or added to the World Wide Web, especially content that is periodically published, released, or distributed. Such content includes, but is not limited to, dated content such as news articles, periodical articles, blog entries, and videos related to current events. A user may access the content directly from the content's sources, such as through newspapers', periodicals', or broadcasters' websites, or through blogs maintained by individual authors. However, the proliferation of web content has resulted in a phenomenon referred to as “information overload,” whereby users, given the large amount of content available to browse, are unable to locate and view the content that they would prefer to select for viewing.

Publisher pages collect and cull content into expandable digests to present to a user within one reasonably-sized webpage. An example of a publisher page is Yahoo! Front Page (http://www.yahoo.com). The expandable digests show titles, synopses, excerpts, or images relating to the greater content. Because a user viewing such a webpage can see a large majority of the digested content at a glance, the user can better decide which content he would prefer to expand. Expanded content can be shown, for example, in an area of the same webpage that showed the digest, or in another webpage.

To attract the most users to a publisher page, publisher pages strive to include content that would be preferred by a largest group of users. Users that find preferred content on a publisher page are more likely to visit the publisher page again, which may incidentally result in a greater revenue stream for the publisher page. In one approach, publishers use human editors to select preferred content to include in the digest. However, using the subjective judgment of human editors is an inefficient and inaccurate way to determine preferred content for users at large, and is not readily adaptable to the frequency with which content is added or updated on websites.

In another approach, the relative preference of users for particular web content, otherwise referred to as the relative popularity of particular content, is measured by tracking the total number of times the content is shown in the digest (also known as a “view” of the digest), and the total number of times the website receives a click event (also known as a “click” of the digest) from a user to expand the digest. Dividing the total number of clicks of the digest by the total number of views of the digest produces the “click-through rate” for the particular content. The click-through rate is therefore an estimate of the likelihood that a user, having viewed the digest, would click to expand it, and is correlated to the popularity of digested content. However, simply cumulatively counting the number of clicks and views to determine a click-through rate for digested content has been found to not accurately determine the true and current popularity of the digested content.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates an arrangement of web content in a display, according to one embodiment of the invention;

FIG. 2 is a flow diagram that illustrates one embodiment for estimating popularity of particular web content from data collected at a single display position;

FIG. 3 is a flow diagram that illustrates one embodiment for estimating popularity of particular web content using data from multiple display positions;

FIG. 4 is a flow diagram that illustrates one embodiment for estimating the popularity of particular web content by incorporating click-through rate decay into click-through rate estimates for individual users; and

FIG. 5 is an example of a computer system on which one embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Techniques are provided for estimating the changing popularity of web content over time. The popularity for particular web content is based on a predicted click-through rate for the particular web content. The techniques allow for accurately predicting, for a fixed and proximate future period, the likelihood that a user will click to select particular digested web content.

### Displaying Digests

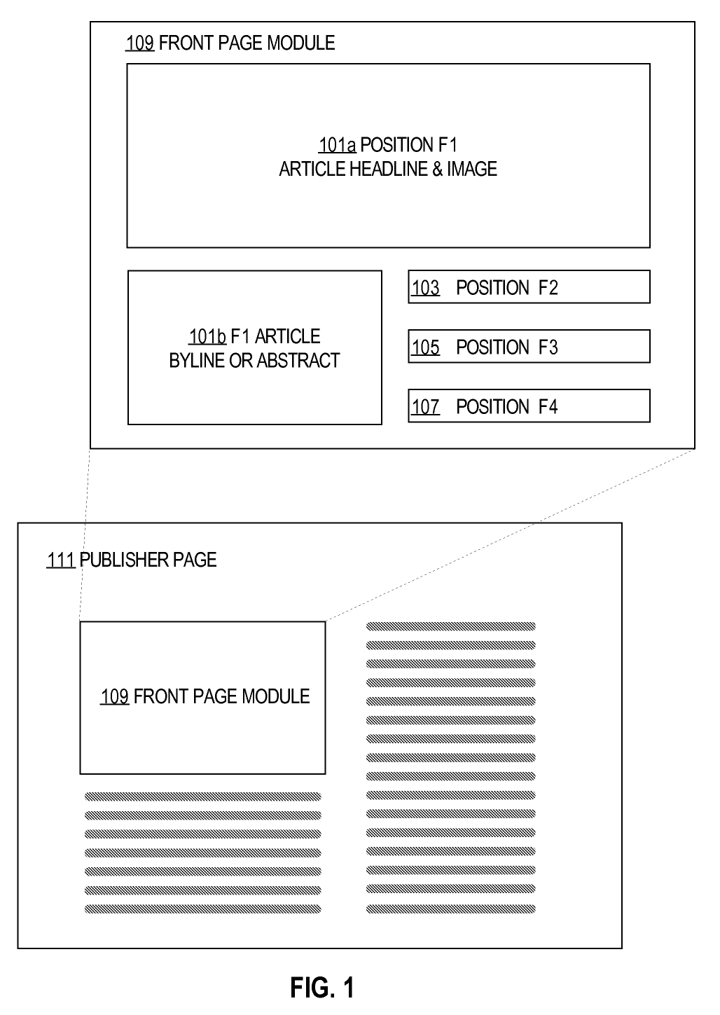

According to one embodiment of the invention, four digests are displayed in positions 101a, 101b, 103, 105, and 107, as depicted in FIG. 1. The four digests are shown within a Front Page Module 109 that is included in a publisher page 111. In the arrangement shown in FIG. 1, areas 101a and 101b are together the first position F1, area 103 is the second position F2, area 105 is the third position F3, and area 107 is the fourth position F4.

As shown in FIG. 1, the areas in the front page module that are given to the F1 position are larger than the areas given for the other positions. The F1 position at 101a displays an image and a headline for the article. Additionally, an area 101b in the module displays a byline for the article. Either of 101a or 101b can be clicked by a user to view an expanded version of the digest in another web page.

“Position bias” describes the observation that users intrinsically prefer selecting content in certain positions over other positions, regardless of the content. Due to the position bias, the predicted click-through rate for a particular article's digest will differ depending on the position at which it is published. In order to determine an accurate predicted click-through rate for an article, the article's position is considered when collecting and analyzing data from each position.

### Estimating Web Content Popularity Using Single-Position Data Sampling

In one embodiment, candidate web content is shown randomly to users to estimate the popularity of candidate web content. Candidate web content is web content of a type that is deemed appropriate for inclusion on the publisher page, which may typically include, but is not limited to, news stories and articles, videos of current events, and blog entries and other dated content. Four randomly selected digests from a plurality of candidate web content items are shown in the positions described above, and the click-through responses are tracked for each of the digests. While the techniques herein are used to estimate the popularity of dated materials, the techniques may be applied to estimate the popularity of a broader range of web content.

As previously discussed, one objective of estimating the popularity of web content is to attract the most users to a publisher page by including content that would be preferred by a largest group of users. Accordingly, in the embodiment, at any given moment, randomly selected content is shown to a proportion of users who load the publisher page in order to estimate the popularity of the candidate web content. This proportion of users are referred to hereinafter as “test users.” The remaining proportion of general users who load the publisher page are shown web content that has previously undergone the estimation process, also referred to as “estimated-most-popular web content,” or EMP web content, which has a high probability of being selected, or “clicked,” when displayed to general users.

It has been observed that the likelihood that a user will click on particular web content in a particular display position on a web page changes over time. Such a click-through rate is observed to change dramatically over the course of a day or within several hours. Thus, a click-through rate for a published article in the next hour may be different than a click-through rate of a previous hour. Due to this phenomenon, cumulatively counting the number of clicks and views for a candidate article from the time the article is first selected for random showing may be an inaccurate method for determining the current click-through rate because cumulatively counting produces an average click-through rate over the current life of the article.

One possible solution is to sample clicks and views over a shorter time period, and to re-calculate the click-through rate periodically based on the most recent period's data. The length of the period can be adjusted to optimize the accuracy of the estimate. While this approach improves the accuracy of the estimate over the cumulative approach discussed above, this approach does not provide optimal accuracy due to a number of factors. For example, analyzing data collected during a short period may improve the freshness of the data; however, the estimate may be tainted by statistical noise due to the reduced sample size. Lengthening the period will increase sample size and decrease statistical noise; however, the estimate may not be optimally accurate if the popularity is dramatically fluctuating over short periods.

Increasing sample size to decrease statistical noise without lengthening the periods for data collection can also be achieved by increasing the proportion of test users who are shown randomly selected candidate web content during a period. However, showing to more test users randomly selected candidate web content is suboptimal because such an approach causes unpopular content to be shown, and may have the undesired effect of repelling users from the publisher page. To minimize such a detrimental effect, the proportion of test users who are shown the randomly selected candidate web content should be optimally chosen.

According to one embodiment of the invention, the number of times the content is shown or displayed in a digest (also known as a “view” of the digest), and the number of times the website receives a click event (also known as a “click” of the digest) from a user to expand the digest are tracked and counted over many short and discrete time periods. In this embodiment, to avoid position bias, click and view statistics are maintained independently for each of the four display positions for the digested content on the publisher page. For purposes of illustration, examples are shown with respect to estimating the popularity of web content displayed at area 101a and 101b (or “F1”) of FIG. 1, though the examples may apply to estimating the popularity of web content displayed at other positions and other position configurations.

In the embodiment, like in the cumulative approach, all clicks and views that are tracked for the content are used to determine a click-through rate for the content. However, in contrast with the cumulative approach, the click count and view count for each short time period are adjusted to account for the statistical noise that is present. In particular, the click counts and the view counts are adjusted such that more recent data has more influence than older data for purposes of estimating a current click-through rate for the content.

The current popularity of web content at time t is estimated by an estimated click-through rate αₜ/γₜ, wherein adjusted clicks and adjusted views can be represented by the following equations:

αₜ=δαₜ₋₁+cₜ

γₜ=δγₜ₋₁+νₜ (1)

αₜ represents an adjusted, or effective click count for time interval t, and γₜ represents an adjusted, or effective view count for time interval t. The above equations provide recursive definitions for αₜ and γₜ in the sense that are the effective click and view counts from a previous time interval t−1 are used to define the effective click and view counts for a current time interval t.

cₜ represents the click count that is collected during time interval t, and νₜ represents the view count that is collected at time interval t. The effective click count and the effective view count for the previous time interval t−1 adjusted by multiplication with a down-weight δ, where 0≦δ≦1. The down-weight δ is a tuning parameter that is selected to optimize the system. Down-weight δ is periodically adjusted to fit historical click and view data that is collected for the particular content. The down-weighted effective click count δαₜ₋₁ and view count δγₜ₋₁ are added to the current click count cₜ and view count νₜ, respectively, to produce effective click count αₜ and effective view count γₜ. At each new time t (t=1, 2, 3, . . . ), effective click count αₜ and effective view count γₜ are updated using Equation 1.

At the first time interval t=1, when the content is first displayed to users, there is no prior click and view data collected for the content. Accordingly, there is no effective αₜ₋₁ and γₜ₋₁ that was determined for the content. During such first time intervals when the content is first introduced, initial click and view values are chosen for α₀ and γ₀ for using with Equation 1. In one embodiment, the α₀ and γ₀ are chosen using historical click and view data collected from other content. To improve accuracy, the historical data is further separated into categories, such as historical sports content or historical political content, and historical data from an appropriate category is used for the initial determination of effective click count αₜ and effective view count γₜ at t=1.

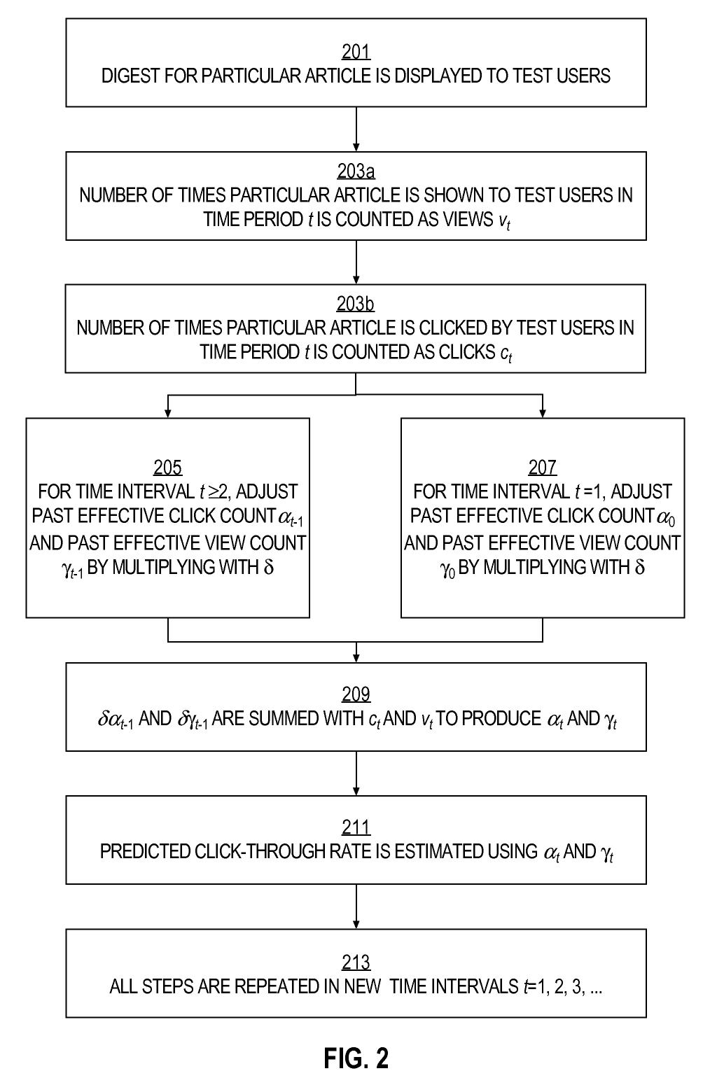

FIG. 2 is a flow diagram that illustrates an approach for estimating popularity of particular web content with good accuracy according to one embodiment of the invention.

In step 201, test users are shown a digest for a particular article that was randomly selected to be shown. In step 203a, the number of users in the group of test users who are shown or displayed the particular randomly selected digest during a time interval t are counted as the number of views νₜ, and at step 203b the number of times the users in the group select the digest for expansion are counted during the time interval t as click events cₜ.

Accordingly, in time interval t, the total number of clicks is cₜ, and the total number of views is νₜ. The click-through rate for the digest during time interval t is cₜ/νₜ. As discussed above, such a per-interval click-through rate is not optimally accurate due to the statistic noise that results from the small sample size.

In step 205, for time interval t≧2, a past effective click count αₜ₋₁ and a past effective view count γₜ₋₁ that were determined during past time intervals are adjusted by multiplication with a down-weight δ, where 0≦δ≦1. The down-weight δ is a tuning parameter that is selected to optimize the system. Alternatively, in step 207, for time interval t=1, appropriate historical effective click count α₀ and effective view counts γ₀ are adjusted by multiplication with a down-weight δ. In step 209, the adjusted click and view numbers, δαₜ₋₁ and δγₜ₋₁ respectively, are summed with the most recent count of clicks cₜ and views νₜ to produce a current “exponentially weighted” click value αₜ and current “exponentially weighted” view value γₜ, respectively. In step 211, the predicted click-through rate can be represented as αₜ/γₜ.

In step 213, as time continues, where time interval t=(((t+1)+1)+1 . . . ), αₜ and γₜ are determined for each new current time interval t until the article is removed as a candidate article.

### Estimating Web Content Popularity Using Multi-Position Data Sampling

As discussed above, due to position bias, click and view statistics are maintained independently for each of the four display positions for the digested content on the publisher page. When the above single-position click-through rate estimation process is performed for one particular article at each of the four positions independently, it is observed that there are differences between the click-through rates at each position. When differences vary widely, summing click and view data that are collected from all the positions to estimate a click-through rate at a target position would not produce an optimally accurate estimate for the target position.

According to one embodiment of the invention, the different estimated click-through rates determined at each of the other positions for the particular article are used to refine the click-through rate estimate at the target position. In this embodiment, the differences in the click-through rate estimate between the target position and each of the other positions are determined. Once the differences are determined, then statistics calculated for the other positions can be converted into additional data that are used to estimate the click-through rate for the target position. This embodiment effectively increases the sample size used to estimate the click-through rate for the target position.

A difficulty that has been observed for determining the differences in the click-through rate estimate between the target position and each of the other positions is that the differences shift over time. For example, the difference in click-through rates between showing a particular article at area 101 and area 103 is not constant over time. As a result, in order to use the data from other positions to extrapolate data from the target position, the relationship between the statistics produced at each position needs to be adjusted over time in order to maintain accuracy.

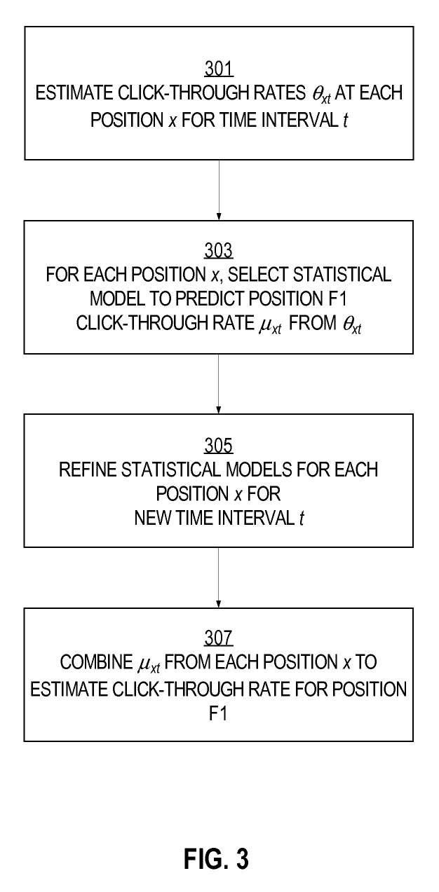

FIG. 3 is a flow diagram that illustrates one embodiment for estimating popularity of particular web content using data from multiple display positions. At step 301, a click-through rate

$${θ}_{t} = \frac{{α}_{t}}{{γ}_{t}}$$

is estimated for an article for time interval t for each of the display positions. Although the process described above can be used to estimate click-through rate, this embodiment for estimating popularity of particular web content using data from multiple display positions may be applied to estimated popularity ratings that have been derived by other methods. This embodiment may also be applied to using the estimated popularity ratings from different display positions than those depicted in FIG. 1, or that are determined using parameters other than clicks and views.

At step 303, a statistical model is chosen to model the respective relationship between the popularity estimate at the target position 1 and at each of the other positions x. In this embodiment, θₓₜ is used to denote the exponentially weighted click-through rate αₜ/γₜ that is determined for position x, using single-position data from position x. θ₁ₜ is used to denote the exponentially weighted click-through rate for target position 1, using single-position data from target position 1. In the embodiment, a linear regression model can be assumed for the relationship between click-through rates θ₁ₜ and θₓₜ over time, as follows:

θ₁ₜ=αₓₜ+βₓₜθₓₜ+error (2)

While a linear regression model is assumed for relationship between θ₁ₜ and θₓₜ, any statistical model that accurately represents the relationship may be used. αₓₜ and βₓₜ denote the intercept and slope, respectively, of the simple linear regression model between θ₁ₜ and θₓₜ. In one embodiment of the invention, αₓₜ and βₓₜ are solved by applying linear regression techniques on click-through rate data collected for each article at each position. If there is no click-through rate data because t is the first time interval in which the article is shown, then historical data based on the relationship between θ₁ₜ and θₓₜ for other articles are used to approximate the function for an initial time point.

At step 305, the relationship between the click-through rates of a particular article at position 1 and position x, respectively, are periodically refined as new click and view data are collected for the article for a next period. Thus, the model for the relationship is a dynamic model. For example, αₓₜ and βₓₜ in the above linear-regression model are adjusted to fit the relationship between θ₁ₜ and θₓₜ according to the click and view data that are observed through the latest time interval.

According to one embodiment of the invention, αₓₜ and βₓₜ are estimated and updated by using a Kalman filter. The Kalman filter is well-known in the art, and is also described in Bayesian Forecasting and Dynamic Models, by M. West and J. Harrison, Springer-Verlag, 1997, which is incorporated by reference into this application as if fully set forth herein. In this embodiment, the Kalman filter is used with the sequence of θ₁ₜ and θₓₜ that are determined for each time interval t, t−1, t-2, . . . to estimate αₓₜ and βₓₜ for the current time interval t. The Kalman filter may be used if the assumption is made that the fluctuation of αₓₜ and βₓₜ at successive time points follows a normal distribution with a mean of zero, and a variance that follows a covariance matrix. Other dynamic modeling techniques for dynamically estimating αₓₜ and βₓₜ at successive time points may also be used.

At step 307, after using Equation 2 to determine three independent models that estimate the relationship between θ₁ₜ and θₓₜ for all positions x, the results are combined to estimate the click-through rate at position F1. μₓₜ is used to denote an estimated click-through rate for the target position that is estimated from data collected at each position x. Accordingly, μ₁ₜ denotes the click-through rate of position 1 that is estimated from data collected when the article is shown at position 1, and μ₂ₜ denotes the click-through rate of position 2 that is estimated from data collected when the article is shown at position 2, etc. The four estimates derived from four independent models, μ₁ₜ, μ₂ₜ, μ₃ₜ, μ₄ₜ, are combined by taking a weighted sum of the four estimates. The weighted sum is based on the respective variance σ²ₓₜ at each of the positions x, and can be expressed by the following:

$$Position 1 Popularity {Estimate}_{t} = {\sum }_{x} ( \frac{\frac{1}{{σ}_{xt}^{2}}}{{\sum }_{x} \frac{1}{{σ}_{xt}^{2}}} ) {μ}_{xt} \qquad ( 3 )$$

The resulting weighted sum for the article is the popularity estimate for the article based on multi-position data sampling, and is used to estimate the current popularity of the article relative to other articles for which popularity estimates are similarly determined.

### Simultaneous Estimation of Web Content Popularity Using Multi-Position Data Sampling

In the embodiment of the invention described above, results are first obtained from four independent models, and the independent results are combined into a weighted sum to determine one result from the four independent models. In the example used above, a click-through rate for a particular article at a particular position is determined from data collected at the particular position. The procedure is repeated independently for each of the other positions. The relationships between the positions are determined so that the click-through rate for a target position can be estimated from the click-through rate of one of the other positions. Each of the derived click-through rates for the target position is combined as a weighted sum to generate a composite click-through rate estimate for the article shown at the target position.

Alternatively, instead of producing independent sub-results that are later combined, a click-through rate estimate for the article shown at the target position is directly estimated from click and view data from all the positions as the data becomes available for a current time interval.

The popularity of particular web content can be estimated by simultaneously using data from multiple display positions K to directly derive the click-through rate estimate. The approach comprises two processes: an offline training process, and an online estimation process.

For the offline training process, a standard statistical distribution is assumed in order to model a vector of clicks c observed at each position over time such that the mean of the click vector distribution is assumed to be θν, where θ is the vector of click-through rates observed at each position and ν the vector of views observed at each position; for some distributions, additional parameters Θ may be needed to specify the distributions. Using cᵢₜ and νᵢₜ to denote the number of clicks and the number of views of the particular article at position i at time t, and θᵢₜ to denote the click-through rates of the particular article at position i at time t, the mean and variance of the probability distribution D can be expressed by the following expression:

$$[ \begin{matrix}{c}_{1 t} \\ {c}_{2 t} \\ {c}_{3 t} \\ {c}_{4 t}\end{matrix} ] \sim D ( mean = A [ \begin{matrix}{θ}_{1 t} & {v}_{1 t} \\ {θ}_{2 t} & {v}_{2 t} \\ {θ}_{3 t} & {v}_{3 t} \\ {θ}_{4 t} & {v}_{4 t}\end{matrix} ] , Θ ) \qquad ( 4 )$$

According to one embodiment of the invention, a Poisson distribution is accurately assumed for the data, where A is an identity matrix and Θ is empty. In another embodiment, a Gaussian distribution is a reasonable distribution to assume for the data, where A is a matrix (i.e., linear transformation) to be estimated based on historical data, and Θ is the variance-covariance matrix of the multivariable Gaussian distribution to be estimated based on historical data.

In the embodiment, click-through rate changes over time. The changes are modeled by assuming a state-transition model, where the state at time t is the unobserved click-through rate vector [θ₁ₜ, . . . , θ₄ₜ]. In one embodiment, the difference between the current click-through rate θᵢₜ at position i and the past click-through rate θᵢ₍ₜ₋₁₎ is denoted as error term ε, which is assumed to follow a normal distribution with a mean of zero, and a variance that is a covariance matrix Σ. In general, the relationship between a vector of current click-through rates and a vector of past click-through rates can be expressed by the following:

$$[ \begin{matrix}{θ}_{1 t} \\ {θ}_{2 t} \\ {θ}_{3 t} \\ {θ}_{4 t}\end{matrix} ] = B [ \begin{matrix}{θ}_{1 ( t - 1 )} \\ {θ}_{2 ( t - 1 )} \\ {θ}_{3 ( t - 1 )} \\ {θ}_{4 ( t - 1 )}\end{matrix} ] + ɛ , ɛ \sim N ( 0 , \sum ) \qquad ( 5 )$$

where B is a matrix (i.e., linear transformation) estimated using historical data; one choice is an identity matrix. When D in Equation 4 is assumed to be Gaussian, a linear dynamical system, also known as a linear Gaussian state-space model is used as a model for learning a posterior distribution for the true click through rate θᵢₜ at position i from data collected at each of the positions.

For the online estimating process, click and view data are gathered for a particular article at each of the display positions on a webpage. Techniques using a multivariate Kalman filter update rule are applied to estimate posterior distribution through time.

A detailed implementation of using a linear Gaussian state-space model to perform simultaneous tracking of click-through rate of web content using data from multiple positions is included in this application in Appendix A.

### Incorporating Click-Through Rate Decay Into Click-Through Rate Estimates for Individual Users

A click-through rate for particular web content decays over time due to repeated exposure of users to the particular web content. Repeated exposure is dependent on many factors, such as repeated views of the article by a user, repeated clicks of the article by a user, or the time elapsed since the article was first displayed to a user. Accordingly, an exposure profile of a user encompasses the specific counts for each factor that a user has accrued with respect to a particular article. Users whose exposure profiles are common show similar click-through rate decay patterns. For example, users who each have been shown a digest for an article five times, who each have clicked on the article once, and for whom five hours have elapsed since the article's digest was first displayed, all exhibit a similar click-through rate for the article.

Due to the observed differences in click-through rates as correlated with the numerous possible exposure profiles among users, it would not be optimal to apply one click-through rate estimate to rank the popularity of articles for all users. Accordingly, data from test users are used to determine a relationship between the exposure profile and click-through rate decay, and general users are shown articles depending on the general user's individual exposure profile.

According to one embodiment of the invention, one exposure profile is selected as the baseline exposure profile for calibrating click-through rates of users having different exposure profiles. Exposure profiles can be expressed as a feature vector R=[i,j,k]. According to one embodiment of the invention, the exposure profile with zero repeated views, zero repeated clicks, and no elapsed time since the article was first displayed, is a first-view exposure profile R=[0,0,0]. In other words, the click and view data of users for whom the article is first-viewed is used to estimate a baseline click-through rate for the article.

A first-view click-through rate θ0t and a click-through rate θ_{Rt} with a particular feature vector R, are related by function ƒₜ(R) as expressed by the following equation:

θ_{Rt}=θ₀ₜ·ƒₜ(R) (6)

Using click and view data collected from all the test users, standard machine-learning techniques can be used to determine the function ƒₜ(R) from the collected data for any R.

In one embodiment of the invention, a procedure for estimation in Kalman filter theory for use with non-linear observation equations is executed as follows. A log-linear form is assumed for ƒ(R), e.g., log(ƒ(R))=βₜ′R. Accordingly, the f is estimated through a Kalman filter through a Laplace approximation, i.e., at time t, the posterior mode and Hessian of βₜ are computed, which provide an updated estimate.

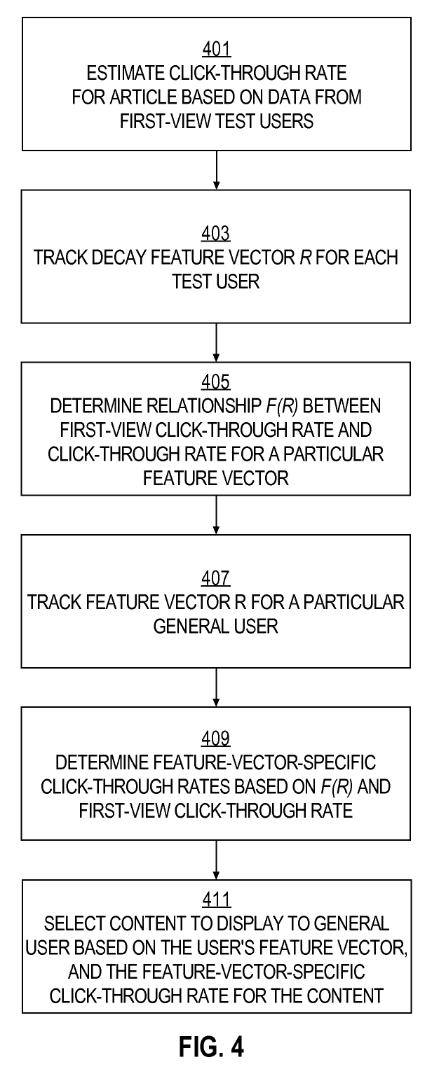

FIG. 4 is a flow diagram that illustrates one embodiment for estimating the popularity of particular web content by incorporating click-through rate decay into click-through rate estimates for individual users. At step 401, a click-through rate is estimated for particular web content at a particular position based on click and view data that are collected exclusively from first-view users. First-view users have an exposure profile of zero repeated views for particular web content, zero repeated clicks for the web content, and no elapsed time since the web content was first displayed. While the techniques described above can be used to estimate the click-through rate, any method for estimating click-through rate using data from first-view users can be used.

At step 403, factors that contribute to click-through rate decay are tracked for each particular test user. Such factors include repeated views of the web content by a user, repeated clicks of the web content by a user, or the time elapsed since the web content was first displayed to a user. The factors are expressed as a feature vector R=[i, j, k]. For example, the first value i in the vector tracks the number of repeated views of the web content for any particular user. The second value j in the vector tracks the number of repeated clicks of the web content by any particular user. The third value k tracks the time, in minutes, that has elapsed since the web content was first displayed to the user.

At step 405, data collected from test users with the feature vector R (e.g., R=[2, 0, 15]), as well as data collected from first-view test users, are used with machine learning techniques to determine the relationship ƒ(R) between first-view click-through rate and the click through rate of users having the feature vector R.

At step 407, a feature vector R for a general user is determined with respect to candidate web content. At step 409, using the function ƒ(R), and the undecayed first-view click-through rate determined for the article, a feature-vector-specific click-through rate is estimated for the article. Steps 401-407 are repeated with respect to all candidate web content to produce user-specific click-through rate estimates for all the candidate web content.

At step 411, using the respective user-specific estimated click-through rates for all candidate web content, specific web content is chosen for display to the general user. In this embodiment, the web content having the highest user-specific estimated click-through rates are chosen for displaying to the general user.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

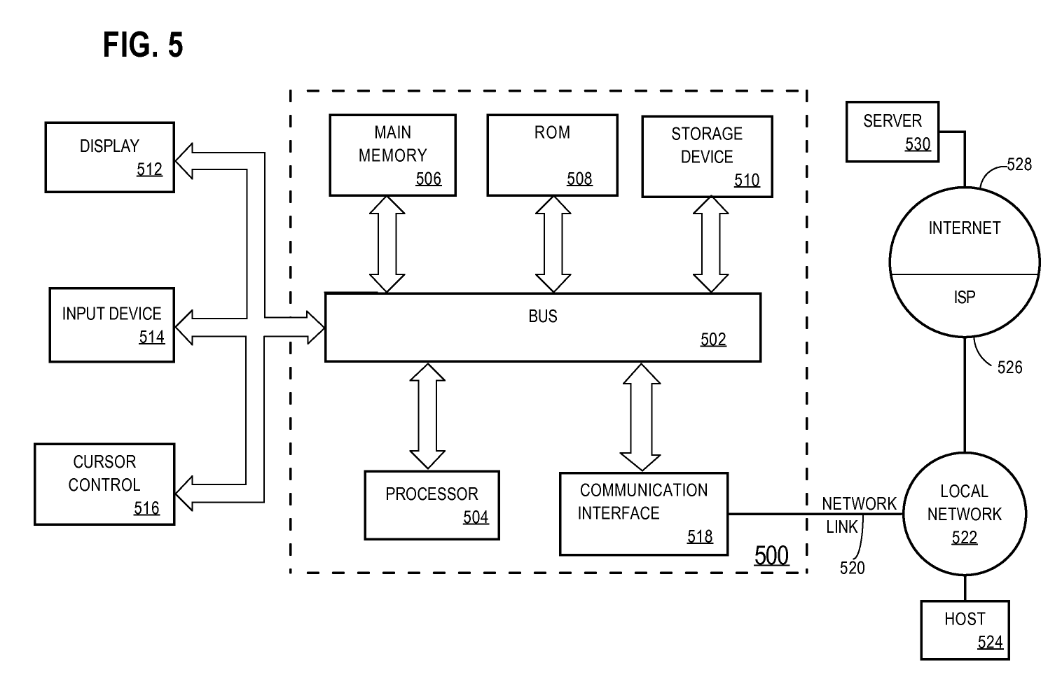

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method comprising:
receiving, at a machine during a past time interval, one or more requests to display web content;
in response to each of said one or more requests during said past time interval:
sending particular web content for display during said past time interval;
determining a past display value for said past time interval for said particular web content;
determining a past selection value for said past time interval for said particular web content;
adjusting said past display value by a first tuning parameter to produce an adjusted past display value;
adjusting said past selection value by a second tuning parameter to produce an adjusted past selection value;
receiving, at said machine during a next time interval, one or more requests to display web content;
in response to each of said one or more requests during said next time interval:
sending said particular web content for display during said next time interval;
determining a current display number that indicates a number of times said particular web content is displayed on a web page during said next time interval;
determining a current selection number that indicates a number of times said particular web content is selected on a page during said next time interval;
determining a weighted display value that is based on said adjusted display value and said current display number;
determining an weighted selection value that is based on said adjusted selection value and said current selection number; and
determining a predicted selection rate for said particular web content based on said weighted display value and said weighted selection value.

2. The method of claim 1, further comprising the steps of:
receiving, at said machine during a second next time interval, one or more requests to display web content;
in response to each of said one or more requests during said second next time interval, determining whether to send said particular web content for display based on said predicted selection rate for said particular web content.

3. The method of claim 2, wherein said one or more requests to display web content during said second next time interval is received from a general user.

4. The method of claim 2, wherein the step of determining whether to send said particular web content for display based on said predicted selection rate for said particular web content further comprises:
determining whether said predicted selection rate indicates that said particular web content has a high probability of being selected; and
sending said particular content for display only if said predicted selection rate indicates that said particular web content has a high probability of being selected.

5. The method of claim 1, wherein said past display value indicates a number of times said particular web content is displayed on a web page during a time interval, and wherein said past selection value indicates a number of times said particular web content is selected on a web page during a time interval.

6. The method of claim 1, wherein said past display value is a weighted display value that was determined for a past time interval, and wherein said past display value is a weighted display value that was determined for a past time interval.

7. The method of claim 1, wherein said particular web content is randomly selected for displaying to a set of test users.

8. The method of claim 1, wherein said particular web content is selected on a page when a click event is received for said particular web content.

9. The method of claim 1, wherein said web content includes new stories, news articles, videos, or blog entries.

10. One or more storage media storing instructions which, when executed by one or more computing devices, cause performance of the method recited in claim 1.

11. One or more storage media storing instructions which, when executed by one or more computing devices, cause performance of the method recited in claim 2.

12. One or more storage media storing instructions which, when executed by one or more computing devices, cause performance of the method recited in claim 3.

13. One or more storage media storing instructions which, when executed by one or more computing devices, cause performance of the method recited in claim 4.

14. One or more storage media storing instructions which, when executed by one or more computing devices, cause performance of the method recited in claim 5.

15. One or more storage media storing instructions which, when executed by one or more computing devices, cause performance of the method recited in claim 6.

16. One or more storage media storing instructions which, when executed by one or more computing devices, cause performance of the method recited in claim 7.

17. One or more storage media storing instructions which, when executed by one or more computing devices, cause performance of the method recited in claim 8.

18. One or more storage media storing instructions which, when executed by one or more computing devices, cause performance of the method recited in claim 9.
